(19) United States
(12) Patent Application Publication
(10) Pub. No.: US 2004/0200955 A1
(43) Pub. Date: Oct. 14, 2004

(54) Position detection of a light source

(76) Inventor: Aleksandr Andzelevich, Plymouth, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/409,835

(22) Filed: Apr. 8, 2003

(51) Int. Cl. G06M 7/00

(52) U.S. Cl. 250/221

(57) ABSTRACT

A position detecting device has a first surface with an electromagnetic wave sensing matrix capable of generating position information regarding projections of multiple electromagnetic waves on the surface. A mask has two spaced apart holes for passing electromagnetic waves generated by an electromagnetic wave source when the mask is between the first surface and the source. A method of generating control signals comprises receiving electromagnetic radiation from the first point source at the mask and projecting the radiation from two apertures in the mask to a detection surface that is sensitive to the electromagnetic radiation The received radiation is converted into two sets of coordinates representative of three dimensional motion of the first point source. A device driver is used to perform the method.

### FIELD OF THE INVENTION

The present invention relates to movement detection and in particular to three dimensional movement detection of a light source.

### BACKGROUND OF THE INVENTION

Many methods are currently used to communicate wirelessly with a computer system. In some methods, a camera is used to determine the position of a laser pointer spot on a projected display. The position is converted to cursor control signals corresponding to the position of the spot on the display. In other methods, a light source is pointed at an optical signal detector to generate position information of the point where the light is projected. Still further methods include gyro type sensors within a hand held device that detect motion of the device and transmit the signals to a receiver coupled to a computer for translation into cursor position signals. Such methods are generally expensive, and sometimes difficult to use to effectively position a cursor in a desired manner.

### SUMMARY OF THE INVENTION

A position detecting device has a first surface with an electromagnetic wave sensing matrix capable of generating position information regarding projections of multiple electromagnetic waves on the surface. A mask has one or more spaced apart holes for passing electromagnetic waves generated by an electromagnetic wave source when the mask is between the first surface and the source.

In one embodiment, the electromagnetic wave sensing matrix is a charge coupled device that detects visible light in one embodiment, and includes the ability to distinguish between colors, such as colors from multiple point sources. The electromagnetic wave sensing matrix provides a set of x,y coordinate information corresponding to the projections. The set of x,y coordinates identifies a three dimensional position of the electromagnetic source and may be used to identify intended cursor movements for control of software on a computer, drawing, handwriting, or any other function that can be related to movement.

In one embodiment, the mask has two holes, and the light is projected from the two holes onto the matrix in two different positions. The positions are detected and processed to identify the three dimensional position of the electromagnetic source. In a further embodiment, a single hole is used, and the size and position of the projection on the matrix is determined and converted to identify the three dimensional position of the electromagnetic source. In this embodiment, the power or intensity of the projection may also be used in the conversion process. In yet further embodiments, multiple single or multiple hole detecting devices are positioned in a defined manner, and detected projections are combined to define a three dimensional position of the electromagnetic source.

A method of generating control signals comprises receiving electromagnetic radiation from the first point source at the mask and projecting the radiation from two apertures in the mask to a detection surface that is sensitive to the electromagnetic radiation The received radiation is converted into two sets of coordinates representative of three dimensional motion of the first point source. In further embodiment, the coordinates are converted to identify a location for a cursor. The cursor is displayed on a display device in accordance with the location.

In still further embodiments, selected motions of the cursor are identified as clicks, such as a rapid up and down motion of the point source, or an in and out motion toward and away from the mask. In yet further embodiments, a switch is provided for the point source, allowing controlled clicking on and off of the light source to simulate mouse clicks for cursor control. In a further embodiment, a left and right switch is provided to simulate left and right mouse clicks. Each may provide a predetermined pattern of modulation of the light that is recognizable and distinguishable by the detection surface. In a further embodiment, the position of the light source is converted directly to an action, such as selection of a key in a virtual keyboard.

### BRIEF DESCRIPTION OF THE DRAWINGS

FIG. 1 is a block diagram illustrating operation of a device for generating coordinates corresponding to the position of a source of electromagnetic radiation.

FIG. 2 is a block diagram of a system that can be coupled to the device of FIG. 1.

FIG. 3 is a flowchart illustrating one form of a driver for execution on the system of FIG. 2 to translate the coordinates generated from the device of FIG. 1.

FIG. 4 is a block diagram of an alternative device having multiple holes for projection of light onto a detection matrix.

FIGS. 5A, 5B and 5C are a representation of a coordinate system for the device of FIG. 1.

FIG. 6 is a screen shot of a virtual keyboard utilizing the device of FIG. 1.

FIG. 7 is a representation of a coordinate system for the virtual keyboard of FIG. 6.

### DETAILED DESCRIPTION OF THE INVENTION

In the following description, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

The functions or algorithms described herein may be implemented in software or a combination of software and human implemented procedures in one embodiment. The software comprises computer executable instructions stored on computer readable media such as memory or other type of storage devices. The term “computer readable media” is also used to represent carrier waves on which the software is transmitted. Further, such functions correspond to modules, which are software, hardware, firmware or any combination thereof. Multiple functions are performed in one or more modules as desired, and the embodiments described are merely examples. The software is executed on a digital signal processor, ASIC, microprocessor, or other type of processor operating on a computer system, such as a personal computer, server or other computer system.

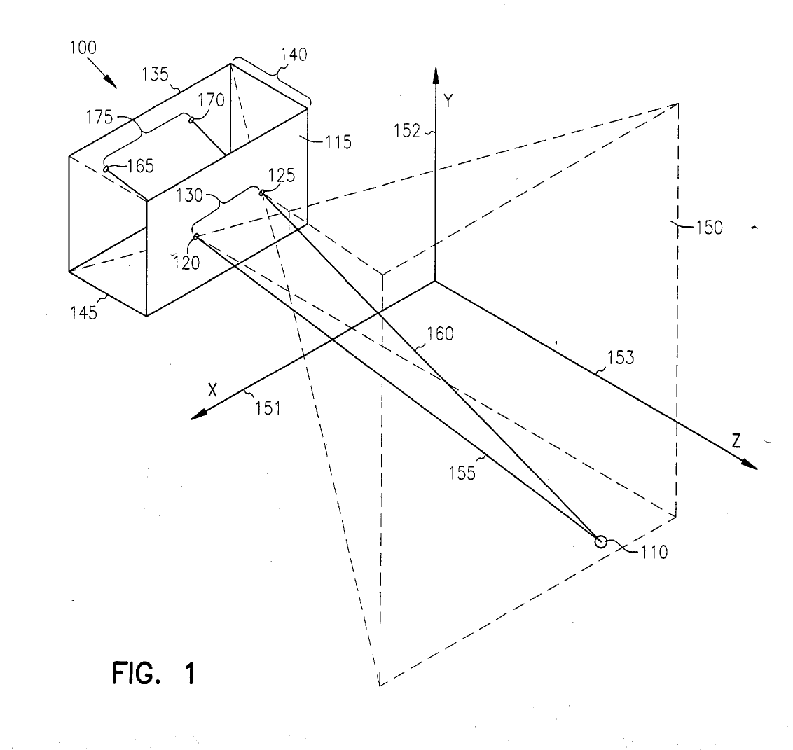

FIG. 1 is a block diagram of a position detection system showing a position detection device 100 for detecting the position of a point source of electromagnetic waves 110. Device 100 comprises a mask 115 having a first aperture 120 and a second aperture 125 separated on the mask 115 by a desired distance identified at 130. An electromagnetic wave sensitive matrix 135 is spaced a desired distance 140 from the mask. The apertures may be simple openings, or include a lens with or without magnifying or other properties. The apertures are designed to project radiation onto the matrix 135 in a manner such that the locations of the projections can be distinguished from background radiation.

In one embodiment, walls 145 are placed between the mask and matrix. The walls 145 help fix the distance 140 and also inhibit electromagnetic waves from falling on the matrix 135, other than those traveling through the apertures.

The point source 110 is shown at one end of an example volume identified by broken lines 150. The volume is represented by a x axis 151 and y axis 152 that are substantially parallel to a surface of the mask and matrix, and a z axis 153 which is perpendicular to the surface of the mask and matrix. The point source 110 emits electromagnetic waves along paths 155 and 160 toward apertures 120 and 125 respectively. As seen in FIG. 1, the paths 155 and 160 proceed through the apertures, and are projected onto the mask at points 165 and 170. These projection points are separated by a distance 175 that is representative of the distance along the z axis of the point source from the mask. The positions of the projection points are representative of the position of the x,y,z coordinates of the point source in the example volume.

Matrix 135 generates matrix x,y coordinates representative of the position of the point source of radiation. In one embodiment, the matrix x,y coordinates are sent to a computer system running a program, such as a device driver, that interprets the matrix x,y coordinates, and converts them to controls for a cursor, or input to an application running on the computer. In a further embodiment, the matrix comprises a charge coupled device such as commonly used in cameras, and the signal from the charge coupled device is sent directly to a computer system which is programmed to recognize the projections and their positions. In a further embodiment, analog video signals are generated and sent to the computer system. Such analog video may be converted using MPEG II encoding to perform analysis to identify positions.

The position detection device 100 may be integrated into a white board, a computer system housing, a display housing, a dongle, a personal digital assistant, a watch, or any other object which has sufficient size. The actual size of the device may be varied greatly for such objects. As indicated above, the relative spacing of the apertures and distance of the mask from the matrix are varied depending on both the size of the object, and the size of the volume desired for detection of the position of the point source of electromagnetic waves.

In one embodiment, the point source of electromagnetic waves is a source of bright visible light of a desired frequency, or in the infrared range. A point source includes a mirror or other reflector of electromagnetic waves from a different source.

In further embodiments, multiple sources of light of varying frequency may be used in conjunction with the position detection device. The detection matrix is able to distinguish the different frequencies, such as red, green or blue, and provide signals to an attached processor that can be converted to separate control signals for cursor control devices or applications. Use of separate frequencies for two devices allows them to be used simultaneously such as by multiple users.

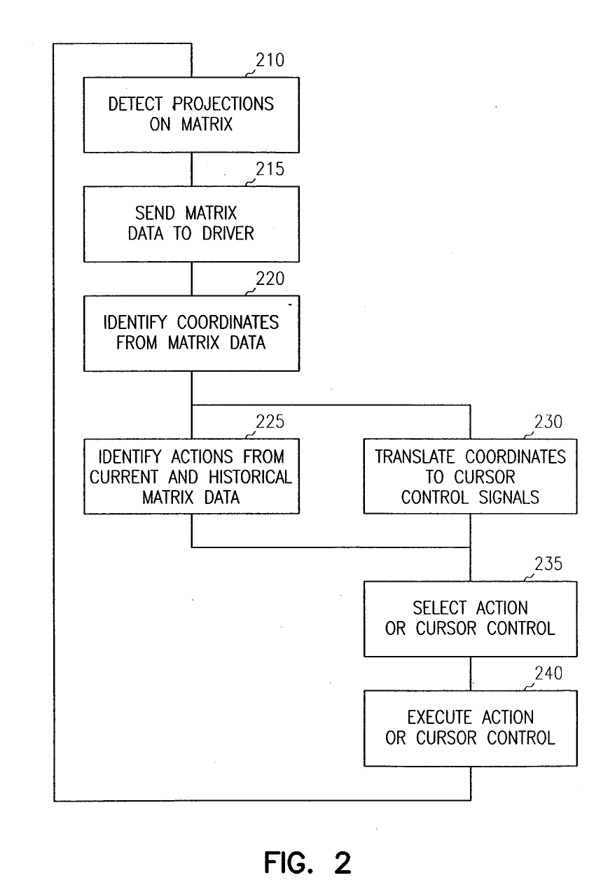

FIG. 2 is a flow chart showing a process for interpreting signals from the detection device 100. There are several alternatives for the signals provided by the detection device 100 as mentioned above. In one embodiment, the detection device has processing elements to convert the detected projections directly into coordinate signals, such as those provided by a mouse or similar cursor control device. In a further alternative, as shown in FIG. 2, the detection device sends signals detected from each element of the matrix. A device driver or other software running on a computer system interprets the signals.

Block 210 represents detecting projections on the matrix. In one embodiment, normal signals from a matrix such as a charge coupled device are then sent to the device driver at 215. Device driver 215 uses image recognition software to determine where the projections are on the matrix. The projections are then used to define the position of the point source in the volume by calculating the x,y and z coordinates based on the separation and position of the projections at 220.

The position information is used at 225 to identify actions from the current position information and from historical position or matrix data, which may be buffered for a predetermined amount of time. The historical data is used to identify particular predetermined motions that may be interpreted as mouse clicks, or other control information. In one example, a quick double lowering and raising of the point source may be interpreted as a double click of a left mouse button. Similar side to side motion may be interpreted as a use of the right mouse button.

Many different motions may be used signify different types of control commands as desired. The buffer is sized to hold sufficient historical coordinate data to interpret such coordinates. In one embodiment, the motions must be completed within a predetermined amount of time that is adjustable by a user. If the position is sampled a known number of times per second, it is easy to calculate the required size of the buffer.

At 230, coordinates are translated to cursor control signals to move the cursor. Several different forms of movement may be selected as desired, such as classic mouse type movements, where the movement only serves to identify the motion of a cursor on a display screen from where the cursor currently resides. In other embodiments, the coordinates are used to identify the precise location of where a cursor or other element of a computer application is located. This absolute location correspondence of the cursor may be useful in creating text on a whiteboard, or for use in certain game applications or three dimensional graphics. For game applications, the coordinates represent temporal information corresponding to natural motion.

The action identified at 225, or the control signals from 230 are then selected at 235. In one embodiment, if an action is identified at 225, it is selected. If not, the cursor control signal is selected. Selection may also depend on various factors associated with application software or user specified options. The action or cursor control signal is then executed at 240 by an application or other software displaying information on a display device. Such a display device may comprise a computer screen, whiteboard, or other device from which text and/or graphics may be perceived.

In one embodiment, the process of FIG. 2 is executed on a processor associated with detection device 100. In further embodiments, the process is executed on a computer system that receives either wireless or wired communication from the detection device. In yet further embodiments, various functions of the process of FIG. 2 are executed partially at each of the detection device 100 and a separate computer system.

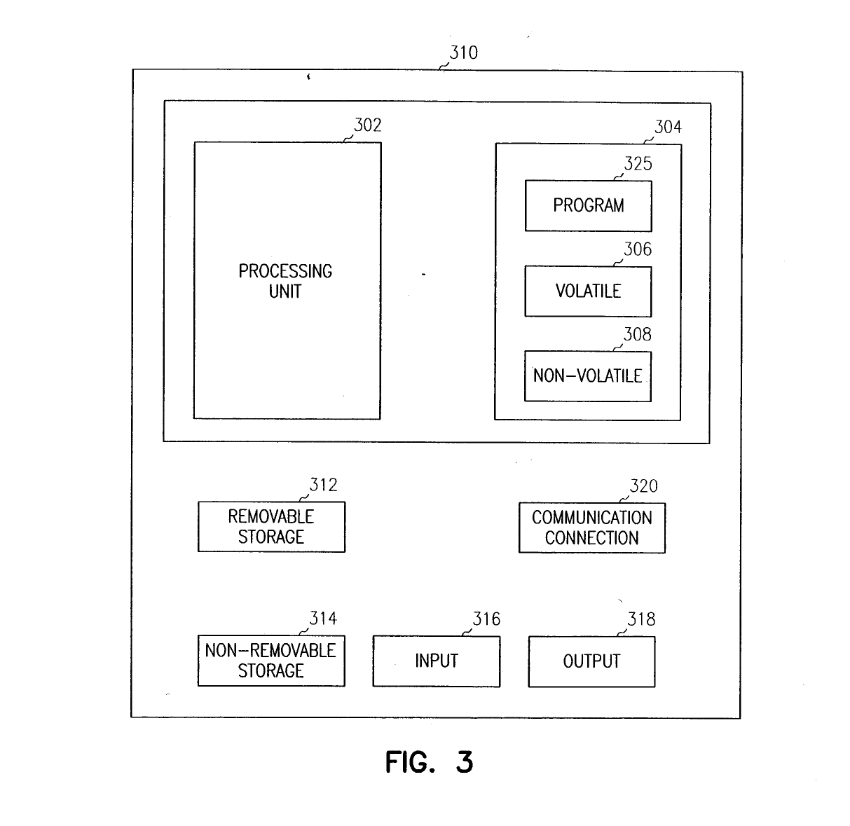

A block diagram of a computer system that executes programming for performing the above algorithm is shown in FIG. 3. Components of the computer system may also be distributed or duplicated at the detection device 100. A general computing device in the form of a computer 210, may include a processing unit 202, memory 204, removable storage 212, and non-removable storage 214. Memory 204 may include volatile memory 206 and non-volatile memory 208. Computer 210 may include—or have access to a computing environment that includes—a variety of computer-readable media, such as volatile memory 206 and non-volatile memory 208, removable storage 212 and non-removable storage 214. Computer storage includes RAM, ROM, EPROM & EEPROM, flash memory or other memory technologies, CD ROM, Digital Versatile Disks (DVD) or other optical disk storage, magnetic cassettes, magnetic tape, magnetic disk storage or other magnetic storage devices, or any other medium capable of storing computer-readable instructions. The driver may be executed for example on processing unit 302 from volatile memory 206. Computer 210 may include or have access to a computing environment that includes input 216, output 218, and a communication connection 220. The computer may operate in a networked environment using a communication connection to connect to one or more remote computers. The remote computer may include a personal computer, server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 202 of the computer 210. A hard drive, CD-ROM, and RAM are some examples of articles including a computer-readable medium. For example, a computer program 225 such as the device driver described in. FIG. 2 may be included on a CD-ROM and loaded from the CD-ROM to a hard drive. The computer-readable instructions allow computer system 200 to interface with the detection device and process signals from the device into cursor position control and action specification.

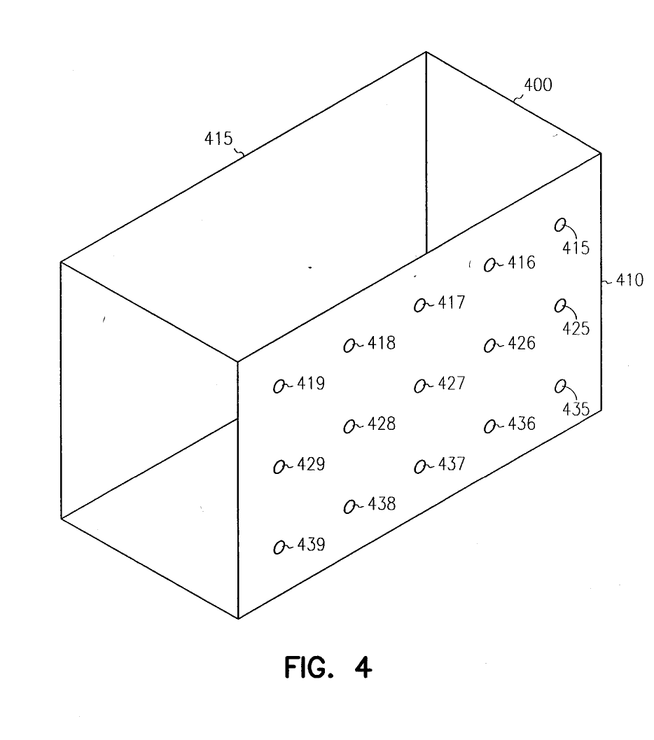

FIG. 4 shows a further detection device 400 having a mask 410 spaced from a detection surface 415. The mask 410 has three rows of multiple apertures or openings. A first row comprises openings 415, 416, 417, 418, and 419. A second row comprises openings 425, 426, 427, 428, and 429. A third row comprises openings 435, 436, 437, 438, and 439. The multiple rows may be utilized to increase the potential volume from which position of point sources of radiation are detectable. The openings in such rows extend wider and higher and lower than a single pair of openings. If the point source is far to the right of the detector as shown, only radiation from openings on the right side of the mask will be projected to the detection surface. In contrast, if the point source is far to the left of the detection device, only radiation from openings on the left side of the mask will be projected to the detection surface. This provides a wider volume in which the position of the point source of radiation may be detected. In the same manner, by having multiple rows of openings, the volume is also higher and lower.

The matrix may also be varied in size and shape. In one embodiment, the matrix is round, or even spherical in order to provide a more linear response to movement of the light source toward the edges of the detection volume. A generally concave detection matrix may also enlarge the volume within which the light source can be accurately detected.

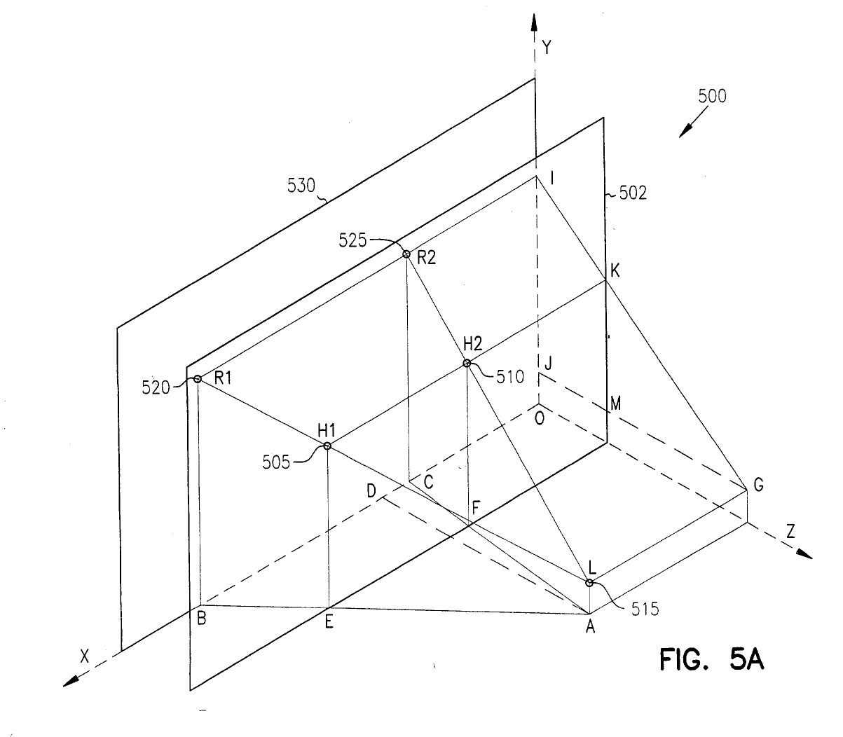

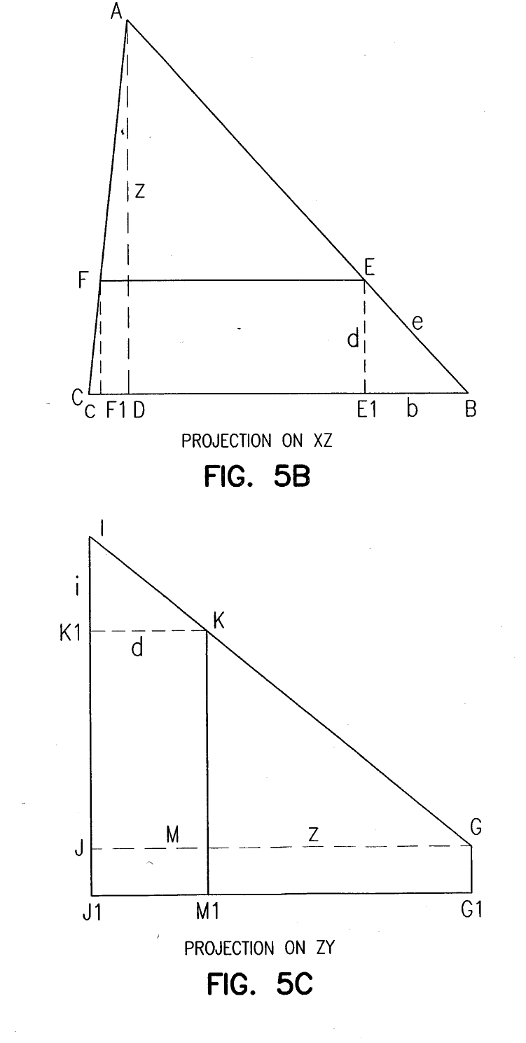

FIGS. 5A, 5B and 5C are an illustration of a geometric model and sample calculations that may be used to determine light source position in a detection device 500 having a mask 502 with two holes H1 and H2 at 505 and 510 respectively. In this embodiment, a light source L at 515 projects light through H1 and H2, resulting in reflections R1 and R2 respectively at 520 and 525 on a detection matrix. 530 situated in the XY field. Screen 502 is substantially parallel to the matrix 530 in one embodiment. In this illustration, capital letters represent points or vertices, and lower case letters represent a distance between such points. FIG. 5A is a perspective view, FIG. 5B is a projection on XZ and FIG. 5C is a projection on ZY.

The z coordinate of the light source is determined as follows:

F−F1=E−E1=K−K1=Distance from Mask to Matrix by OZ (d)

A−D=J−G=Distance from Matrix to Light Source (z)

B−E1=Distance from H1 to R1 by OX (b)

C−F1=Distance from H2 to R2 by OX (c)

z=C−B/(c+b)*d

The x coordinate of the light source is determined as follows:

e=(b²+d²)^{1/2}

A−B=e/d*z

D−B=(A−B²−z²)^{1/2}

OD=coordinate of Light Source by OX (x)

x=OB−D−B

The y coordinate of the light source is determined as follows:

I−K1=Distance from Hs to Rs by OY (i)

I−J=i/d*z

OJ=coordinate of Light Source by OY (y)

y=OI−I−J

Other representations and calculations of the three dimensional position of the light source may be used. This was merely one example of such a calculation.

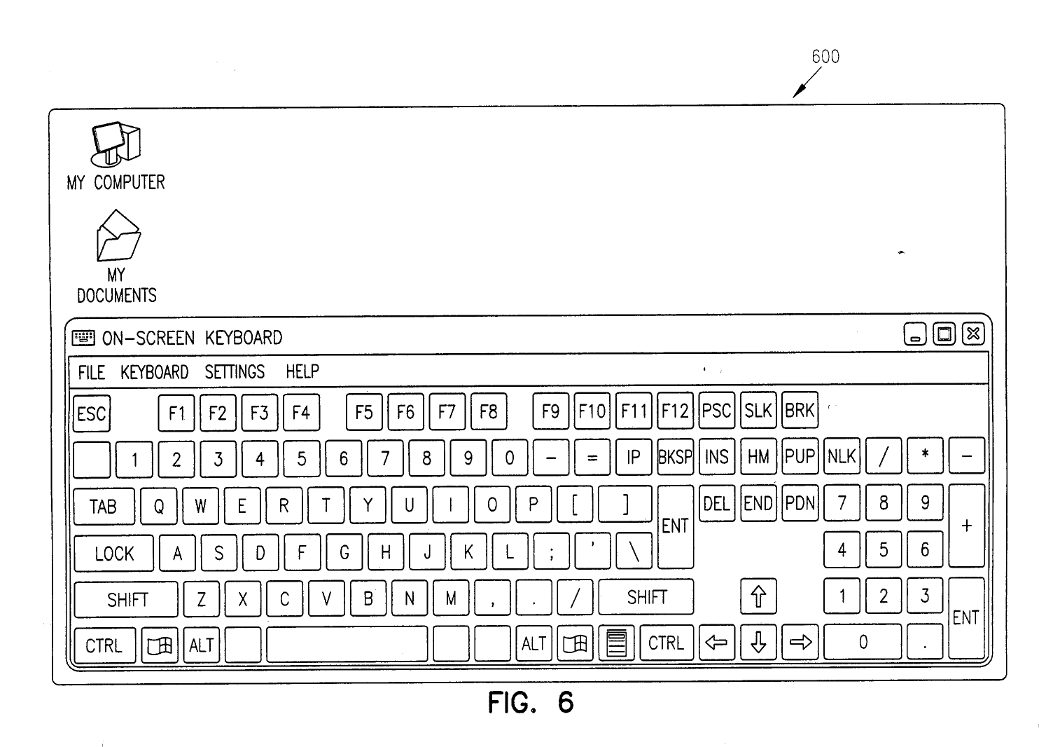

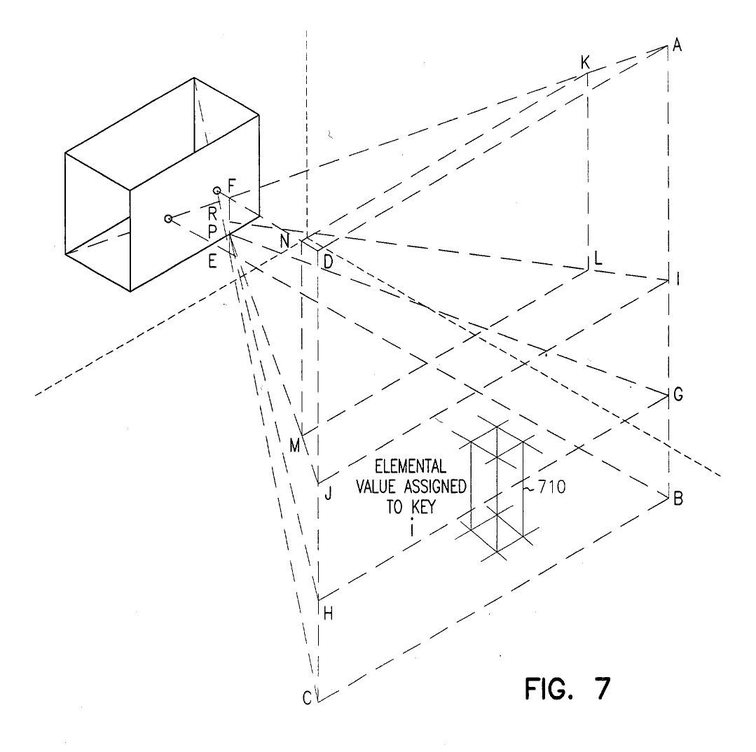

The absolute location correspondence may also be used to create a virtual keyboard 610 in FIG. 6, wherein the keys of a standard keyboard correspond to different positions of the light source, or multiple light sources. In one embodiment, the keys are shown on a display device as seen in FIG. 6, along with the current light source position. The keys are lined up on the bottom of the display or in another format as desired. Cursor control keys may also be identified, such as with a separate section with a free zone as seen in FIG. 7. Each key is located in a free zone, allowing the light source to be navigated from any key to any other key without selecting a key. In one embodiment, a key is selected when the light source passes over it. In a further embodiment, a key is selected with a specific movement of the light source over the key, such as an inward pressing motion. The virtual keyboard may be oriented in any manner desired, such as in an x,z plane to simulate a horizontal keyboard. This allows may more configurations of keys in an unlimited ergonomic manner. In yet a further embodiment, each finger of a user may be equipped with a light source of different frequency, facilitating classic touch typing motions with the virtual keyboard.

The geometry of one example of a virtual keyboard is shown in FIG. 7, in a manner similar to that shown in FIG. 5A. Values may be detected within a light source detectable region defined by A, B, C, D, E and F. Within this region, a sub value is defined by G, B, C, H, P and E. This sub value is dedicated for the virtual keyboard. Values of the virtual keyboard are broken into a set of even smaller sub values referred to as elemental values as shown at 710, which is assigned to key “i” represented as depressed in FIG. 6. Each elemental value is designed to represent a key of the virtual keyboard 600.

Sub value above Virtual Keyboard defined by I, G, H, J R and P allows to move cursor or cursors over the keyboard for selecting desired key or keys. As cursor comes to one of elemental values related key pressing occurs.

Sub value defined by A, I, J, M, N, K and L dedicated for Virtual Mouse. Moving of Virtual Mouse into sub value K, L, M, N, F and R can be considered as mouse key clicking.

1. A position detection device comprising:
a first surface having an electromagnetic wave sensing matrix capable of generating position information regarding projections of multiple electromagnetic waves on the surface; and
a mask having two spaced apart holes for passing electromagnetic waves generated by an electromagnetic wave source when the mask is between the first surface and such source.

2. The position detection device of claim 1 wherein the electromagnetic wave sensing matrix comprises a charge coupled device.

3. The position detection device of claim 2 wherein the matrix is curved.

3. The position detection device of claim 1 wherein the electromagnetic wave sensing matrix provides a set of x,y coordinate information corresponding to the projections.

4. The position detection device of claim 3 wherein the set of x,y coordinates identifies a three dimensional position of the electromagnetic source.

5. The position detection device of claim 1 wherein the holes are sized and spaced from the electromagnetic wave sensing matrix such that the projections comprise points of electromagnetic waves.

6. The position detection device of claim 1 wherein the electromagnetic waves comprise visible light.

7. The position detection device of claim 1 wherein the electromagnetic wave sensing matrix is sensitive to different frequencies of light.

8. The position detection device of claim 7, wherein the electromagnetic wave sensing matrix provides separate x,y coordinates for each different frequency of light.

9. The position detection device of claim 8 wherein the different frequencies are different visible colors of light.

10. The position detection device of claim 1 wherein the mask comprises three holes and the electromagnetic wave sensing matrix provides x,y coordinates corresponding to the projections.

11. A method of generating position signals, the method comprising:
receiving electromagnetic radiation from a first point source at a mask;
projecting the radiation from two apertures in the mask to a detection surface that is sensitive to the electromagnetic radiation; and
converting the radiation received at the detection surface into two sets of coordinates representative of three dimensional position of the first point source.

12. The method of claim 11 wherein the two apertures are spaced apart a distance such that projections of radiation from them are spaced apart on the detection surface, and the distance of the apertures to the detection surface is sufficient to keep the projections of radiation on the detection surface for a desired range of positions of the point source.

13. The method of claim 11 wherein the coordinates comprise x,y,z coordinates corresponding to the position of the first point source.

14. The method of claim 11 wherein the detection surface comprises a charge coupled device.

15. The method of claim 11 and further comprising receiving radiation from a second point source having a frequency distinguishable from a frequency of radiation from the first point source.

16. The method of claim 11 wherein the radiation has a frequency in the visible light spectrum.

17. The method of claim 11 wherein the first point source of light comprises a light coupled to a pointing device.

18. The method of claim 11 wherein the mask and detection surface are integrated into a computer.

19. The method of claim 11 wherein the mask and detection surface are integrated into a white board.

20. The method of claim 11 wherein the mask and detection surface are integrated into a further electronic device.

21. A method of controlling a cursor on a display coupled to a computer, the method comprising:
receiving electromagnetic radiation from a first point source;
projecting the radiation from two apertures separate from the first point source to a detection surface that is sensitive to the electromagnetic radiation;
converting the radiation received at the detection surface into two sets of coordinates representative of position of the first point source;
converting the coordinates to a location for a cursor; and
displaying the cursor on the display in accordance with the location.

22. The method of claim 21 wherein the coordinates are representative of the three dimensional position of the first point source.

23. The method of claim 21 wherein the coordinates are representative of relative positions of the first point source and a receiving device comprising the mask and detection surface.

24. The method of claim 21 and further comprising:
receiving electromagnetic radiation from a second point source, wherein the radiation has a frequency different from the frequency of radiation from the first point source;
projecting the second point source radiation from two apertures separate from the second point source to a detection surface that is sensitive to the electromagnetic radiation;
converting the radiation received from the second point source at the detection surface into two sets of coordinates representative of position of the second point source;
converting the coordinates to a location for a cursor; and
displaying the cursor on the display in accordance with the location.

25. A computer readable medium having instructions for cause a computer to perform a method comprising:
receiving position information from a position detection device having a detection surface that detects radiation from a point source through two openings in a mask spaced a fixed distance from the detection surface;
identifying the position information corresponding to the position of the point source; and
translating the position information into cursor control signals.

26. The computer readable medium of claim 25 wherein the cursor control signals control the position of a cursor on a computer display device.

27. The computer readable medium of claim 26 wherein the cursor control signals represent an action to be executed.

28. A position detection device comprising:
means for receiving light from a point source of light; and
means for receiving projection of light from the point source of light and converting the projection to a three dimensional location of the point source of light.

29. The position detection device of claim 28 and further comprising means for converting the three dimension location of the point source of light into key selections for a virtual keyboard.

30. The position detection device of claim 28 wherein the means for receiving light is a mask having a single hole.
